(19) United States
(12) Patent Application Publication
(10) Pub. No.: US 2005/0130522 A1
(43) Pub. Date: Jun. 16, 2005

(54) Fiber reinforced elastomeric article

(76) Inventors: Kaiyuan Yang, Cumming, GA (US); Thomas Gregory Triebes, Alpharetta, GA (US); Sanford Eric White, Kennesaw, GA (US); Martin S. Shamis, Alpharetta, GA (US)

Correspondence Address: KIMBERLY-CLARK WORLDWIDE, INC., 401 NORTH LAKE STREET, NEENAH, WI, 54956, US

(21) Appl. No.: 10/732,959

(22) Filed: Dec. 11, 2003

(51) Int. Cl. B32B 3/00

(52) U.S. Cl. 442/59; 428/292.1

(57) ABSTRACT

An article made of an elastomeric latex substrate combined with a plurality of tacky polymeric fibers. The fibers form a coherent mat and at least partially adhere to one another to create a fiber reinforced elastomeric article.

### BACKGROUND OF THE INVENTION

The present invention relates generally to a fiber reinforced elastomeric article. More specifically it relates to a natural rubber latex or synthetic polymer latex article reinforced with a plurality of fibers. Examples of such articles may include surgical, clean room, work, and/or industrial gloves where added strength, comfort, skin protection, and powder free aspects are desirable characteristics.

There are many prior art arrangements for producing fiber reinforced elastomeric articles. Most incorporate an internal lining composed of fibrous material such as cotton flock. Typically flock is composed of finely divided, ground, fibrous particles which are applied as a lining by spraying the flock particles onto an adhesive-covered backing (e.g., the external shell of a glove), for example.

As one example, an internal glove lining composed of flock provides a smooth, comfortable feel, cushions the hands, absorbs perspiration and keeps the hands dry, insulates against moderate heat and cold without bulk, makes it easier to put on and take off a glove, and has other advantages which increase worker acceptance of a glove.

Drawbacks to a glove having an internal lining composed of cotton flock (or like fibrous material) are multifaceted: 1) fibers and particles thereof may become detached from the internal lining by abrasion with the surface of the sleeve on the smock or gown worn by the glove wearer or by abrasion with the hand of the glove wearer, and these detached particles can migrate out of the glove, particularly when the glove is removed from the hand of the wearer; 2) fibers like short cotton fibers are not elastomeric, thus are difficult to coat onto disposable gloves made of latex, nitrites, etc.; 3) the current commercial flocking process uses glue to make the short cotton fibers stick, which is essentially a batch process and fibers can not be embedded into the polymer layers effectively; and 4) current commercial flocked gloves, in some cases, uses powder to enhance the donning and comfort, which are not well accepted among consumers because of allergy and health concerns of small particles.

### SUMMARY OF THE INVENTION

The present invention is drawn to an article made of an elastomeric latex substrate combined with a plurality of tacky nonwoven fibers. The fibers form a coherent mat and at least partially adhere to one another to create a fiber reinforced elastomeric article. Such an article results in fibers being bedded or at least partially bedded into the elastomeric substrate so as to enhance the strength of the article when compared to a similar article without fibers.

In one aspect of the present invention, an elastomeric article contains an elastomeric latex substrate impregnated with a plurality of elastomeric fibers. The fibers have a length substantially greater than their width. The fibers are entangled with one another and partially melted into the body of and onto the surface of the elastomeric latex substrate. In some cases the fibers may form a layer partially overlying the elastomeric latex substrate. The fiber layer may be thicker than the elastomeric latex substrate, the fiber layer may be thinner than the elastomeric latex substrate, though the fiber layer may be of any thickness and in any desirable proportion with respect to one another.

Such an article may have fibers that are generally smaller than about 10 microns in average diameter prior to deposition onto the elastomeric latex substrate. However, once deposited onto the elastomeric latex substrate, the fibers are flattened and spread to about 20 microns across an interface formed between the elastomeric latex substrate and the fiber. Articles of this type may be found useful to form among other things, a glove, a condom, a boot, an incontinent pad, a blanket, and apparel. Other articles may be made as well.

In another aspect of the present invention, an elastomeric article having an elastomeric latex substrate combined with a plurality of tacky nonwoven fibers is created. The fibers would form a coherent mat and at least partially adhere to one another as well as the substrate. Such an article may have at least one surface completely coated by the fibers, may envelop the elastomeric latex substrate entirely within the coherent mat of fibers, may have the fibers at least partially impregnated within the elastomeric latex substrate, or may have aspects of each of these possible arrangements.

In another aspect, the elastomeric article may be made of a natural rubber, a synthetic rubber, a nitrile polymer, a neoprene polymer. The fibers may be meltblown fibers, nanofibers, or other polymeric fibers. The resulting article may exhibit a porosity. The porous structure created by the deposition of fibers onto the elastomeric substrate may be capable of containing and releasing a treatment.

These and other objects are achieved by the process disclosed and claimed herein. The invention will be described in greater detail below by reference to embodiments illustrated in the figures.

### BRIEF DESCRIPTION OF THE DRAWINGS

A full and enabling disclosure of the present invention, including the best mode thereof, directed to one of ordinary skill in the art, is set forth more particularly in the remainder of the specification, which makes reference to the appended figures in which:

FIG. 1 is an image from a scanning electron micrograph depicting a cross section of one embodiment of a fiber coated elastomeric article of the present invention where the fiber was coated after the article was dipped into an elastomeric bath.

FIG. 2 is an image from a scanning electron micrograph depicting the interface between a representative fiber and the substrate of the FIG. 1 embodiment.

FIG. 3 is an image from a scanning electron micrograph depicting the interface between the fiber layer and the substrate of the FIG. 1 embodiment.

FIG. 4 is an image from a scanning electron micrograph depicting the porous surface structure of the FIG. 1 article.

FIG. 5 is an image from a scanning electron micrograph depicting the surface structure of another embodiment of an elastomeric article where the fiber was coated before the article was dipped into an elastomeric bath.

FIG. 6 is an image from a scanning electron micrograph depicting the interface between a representative fiber and the substrate of the FIG. 5 embodiment.

### DETAILED DESCRIPTION OF THE INVENTION

In general, an elastomeric article, for example, a glove is formed on a mold, termed as a “former”. In the case of the glove, the former is hand-shaped. Formers may be made from any suitable material, such as glass, metal, porcelain, or the like. The surface of the former defines at least a portion of the surface of the elastomeric article to be manufactured. It is to be understood by one of ordinary skill in the art that the present discussion is a description of exemplary embodiments only, and is not intended as limiting the broader aspects of the present invention. As such, in general, one such exemplary elastomeric article of the present invention includes a glove. For ease of illustration and description the specification often makes reference to the invention as a glove or gloves. It should, however, be understood that the invention is not limited to gloves alone but includes the broader category of elastomeric articles as well. That being said, in the case of the glove, the surfaces defined include an exterior surface and an interior surface. The interior surface is generally the wearer-contacting surface.

In the process, the former is conveyed through a preheated oven to evaporate any water present. The former may then be dipped into a bath typically containing a coagulant, a powder source, a surfactant, and water. The coagulant may contain calcium ions (from e.g., calcium nitrate) that enable a polymer latex to deposit onto the former. The powder may be calcium carbonate powder, which aids release of the completed glove from the former. The surfactant provides enhanced wetting to avoid forming a meniscus and trapping air between the form and deposited latex, particularly in the cuff area. However, any suitable coagulant composition may be used, including those described in U.S. Pat. No. 4,310,928 to Joung, incorporated herein in its entirety by reference. The residual heat evaporates the water in the coagulant mixture leaving, for example, calcium nitrate, calcium carbonate powder, and the surfactant on the surface of the former. Although a coagulant process is described herein, it should be understood that other processes may be used to form the article of the present invention that do not require a coagulant. For instance, in some embodiments, a solvent-based process may be used.

Once the former is coated, it is then dipped into a polymer bath. The polymer bath in the present invention is generally a natural rubber latex or a synthetic polymer latex. The polymer present in the bath includes an elastomeric material that forms the body of the glove. In some embodiments, the elastomeric material, or elastomer, includes natural rubber, which may be supplied as a compounded natural rubber latex. Thus, the bath may contain, for example, compounded natural rubber latex, stabilizers, antioxidants, curing activators, organic accelerators, vulcanizers, and the like. In other embodiments, the elastomeric material may be nitrile butadiene rubber, and in particular, carboxylated nitrile butadiene rubber. In other embodiments, the elastomeric material may be a styrene-ethylene-butylene-styrene block copolymer, styrene-isoprene-styrene block copolymer, styrene-butadiene-styrene block copolymer, styrene-isoprene block copolymer, styrene-butadiene block copolymer, synthetic isoprene, chloroprene rubber, polyvinyl chloride, silicone rubber, polyurethane, or a combination thereof.

The stabilizers may include phosphate-type surfactants. The antioxidants may be phenolic, for example, 2,2′-methylenebis (4-methyl-6-t-butylphenol). The curing activator may be zinc oxide. The organic accelerator may be dithiocarbamate. The vulcanizer may be sulfur or a sulfur-containing compound. To avoid crumb formation, the stabilizer, antioxidant, activator, accelerator, and vulcanizer may first be dispersed into water by using a ball mill and then combined with the polymer latex.

During the dipping process, the coagulant on the former causes some of the elastomer to become locally unstable and coagulate onto the surface of the former. The elastomer coalesces, capturing the particles present in the coagulant composition at the surface of the coagulating elastomer. When making an elastomeric article without fibers, normally, the former is withdrawn from the bath and the coagulated layer is permitted to fully coalesce, thereby forming, as one example, the glove. However, in one embodiment of the present invention, it is at this point that a plurality of fibers are deposited onto the surface of the coagulating elastomer.

To make a fiber reinforced elastomeric article, it has been found that any number of fiber types may be useful in the present invention. Fibers or fibrous material may include natural fibers, synthetic fibers, and mixtures thereof, including meltblown and spunbond.

Suitable fibers include meltspun filaments, staple fibers, pulp fibers, meltspun multicomponent filaments, and the like. Moreover, the fibers may also include various other materials such as elastomeric components. Synthetic fibers or filaments may have any suitable morphology including hollow or solid, straight or crimped, single component, conjugate or biconstituent fibers or filaments, and blends or mixtures of such fibers and/or filaments, as are well known in the art.

As used herein, the term “biconstituent fibers” refers to fibers that have been formed from at least two polymers extruded from the same extruder as a blend. Biconstituent fibers do not have the various polymer components arranged in relatively constantly positioned distinct zones across the cross-sectional area of the fiber and the various polymers are usually not continuous along the entire length of the fiber, instead they usually form fibrils or protofibrils that start and end at random. Biconstituent fibers are sometimes referred to as multiconstituent fibers. Fibers of this general type are discussed in, for example, U.S. Pat. Nos. 5,108,827 and 5,294,482 to Gessner. Biconstituent fibers are also discussed in the textbook Polymer Blends and Composites by John A. Manson and Leslie H. Sperling, copyright 1976 by Plenum Press., a division of Plenum Publishing Corporation of New York, IBSN 0-306-30831-2, at pages 273 through 277.

As used herein, the term “conjugate fibers” refers to fibers that have been formed from at least two polymers extruded from separated extruders but spun together to form one fiber. Conjugate fibers are also sometimes referred to as multicomponent or bicomponent fibers. The polymers are usually different from each other though conjugate fibers may be monocomponent fibers. The polymers are arranged in substantially constantly positioned distinct zones across the cross-section of the conjugate fibers and extend continuously along the length of the conjugate fibers. The configuration of such a conjugate fiber may be, for example, a sheath/core arrangement, wherein one polymer is surrounded by another or may be a side by side arrangement, a pie arrangement or an “islands-in-the-sea” arrangement. Conjugate fibers are taught by U.S. Pat. No. 5,108,820 to Kaneko et al., and U.S. Pat. No. 4,795,668 to Krueger et al., U.S. Pat. No. 5,336,552 to Strack et al. Conjugate fibers are also taught in U.S. Pat. No. 5,382,400 to Pike et al. and may be used to produced crimp in the fibers by using the differential rates of expansion and contraction of the two (or more) polymers. Crimped fibers may also be produced by mechanical means and by the process of German Patent DT 25 13 251 A1. For two component fibers, the polymers may be present in ratios of 75/25, 50/50, 25/75, or any other desired ratios. The fibers may also have shapes such as those described in U.S. Pat. No. 5,277,976 to Hogle et al. U.S. Pat. No. 5,466,410 to Hill, U.S. Pat. No. 5,069,970 to Largman et al., and U.S. Pat. No. 5,057,368 to Largman et al., which describe fibers with unconventional shapes.

As used herein, the term “filament” refers to a generally continuous strand that has a large ratio of length to diameter, such as, for example, a ratio of 1000 or more.

As used herein, “meltblown fibers” refer to fibers formed by extruding a molten thermoplastic material through a plurality of fine, usually circular, die capillaries as molten threads or filaments into converging high velocity, usually hot, gas (e.g. air) streams that attenuate the filaments of thermoplastic material to reduce their diameter, which may be to microfiber diameter. Thereafter, the meltblown fibers are carried by the high velocity gas stream and are deposited on a collecting surface to form a mat or web of randomly disbursed meltblown fibers. Such a process is disclosed, for example, in U.S. Pat. No. 3,849,241 to Butin et al. Meltblown fibers are microfibers that may be continuous or discontinuous, are generally smaller than 10 microns in average diameter, and are generally tacky when deposited on a collecting surface.

As used herein, “spunbond fibers” refer to small diameter fibers that are formed by extruding molten thermoplastic material as filaments from a plurality of fine, usually circular capillaries of a spinneret with the diameter of the extruded filaments then being rapidly reduced as by, for example, in U.S. Pat. No. 4,340,563 to Appel et al., U.S. Pat. No. 3,692,618 to Dorschner et al., U.S. Pat. No. 3,802,817 to Matsuki et al., U.S. Pat. No. 3,338,992 to Kinney, U.S. Pat. No. 3,341,394 to Kinne, U.S. Pat. No. 3,502,763 to Hartman, and U.S. Pat. No. 3,542,615 to Dobo et al. Spunbond fibers are generally not tacky when they are deposited on a collecting surface. Spunbond fibers are generally continuous and have average diameters (from a sample of at least 10) larger than 7 microns, and more particularly, between about 10 and 40 microns.

As stated, in one embodiment, meltblown fibers are applied to the wet elastomeric substrate as it is coagulating on the former. The meltblown fibers may be applied in varying concentrations, i.e., certain regions of the article may be subjected to the application of a greater quantity of meltblown fibers. In the case of a glove, it may be desirable to apply additional meltblown fibers to the palms, finger areas, and/or cuffs. These areas are typically subject to a greater degree of wear and possess a greater potential for tearing. Coincidentally, prior art flocking applications are normally carried out at this stage of manufacture. However, the application of flocking is performed at this stage for a wholly different reason. In the case of the prior art, flocking is added to the still wet elastomeric substrate because it is at this point that the flocking is most apt to adhere to the substrate. In contrast, in the present invention, the meltblown is tacky at the moment of application, i.e., it is still hot enough to be partially melted. As such, the meltblown fibers will adhere to the substrate and to one another thereby forming a coherent mat of randomly oriented fibers.

In another aspect of the invention, small fibers in the submicron range, for example electrospun nanofibers as discussed by (T. H. Grafe et al, Nonwovens in Filtration, Fifth International Conference, Stuttgart, Germany, March 2003), are also suitable for the present invention. Nanofibers, in comparison to larger ones, are capable of forming a much finer web network so that the contact area between substrate and the fiber layer can be further increased. It is also conceivable that such fiber layers based on nanofibers may provide a thinner and more comfortable fiber layer than do larger fibers. In addition, nanofibers may provide better chemical protection because they can provide better filtration sufficiency as known to those practicing in the filtration industry.

Once the fibers have been applied, the former may be again dipped into the polymer bath one or more times for the article to attain the desired thickness. Each time the article is dipped, additional fibers may or may not be applied as desired. In some glove embodiments, the thickness may range from about 0.001 inches (˜0.025 mm) inches (0.102 mm) to about 0.012 inches (0.305 mm). In other embodiments, such as those for use on industrial gloves, the thickness may be significantly greater still. In some embodiments, the thickness may be greater than about 0.4 mm, and may in fact be greater than about 0.5 mm, In yet other embodiments, the thickness may be even greater than this. As such thicknesses between about 1 mm to greater than about 2 mm are contemplated.

Other layers may be formed by including additional dipping processes. Moreover, additional fibers may be added between dipping processes as well. Such dipping processes and/or fiber applications may be used to incorporate additional features into the article.

After the article has been created, a final seal dip into a sealer polymer bath may be performed if desired. Alternatively, the sealer polymer may be applied to the article itself. The sealer polymer has been found to be useful in further locking the fibers into place on the elastomeric article. The sealer polymer may also serve to prevent piling when the glove is stripped or removed from the former. Piling refers to the condition wherein fiber balls are formed on the glove, or worse, are formed and subsequently detach from the glove due to friction at the fiber coated surface when the glove is removed from the former. By way of example the sealer polymer may comprise, for example, a carboxylated acrylic polymer emulsion such as ˜2% Synthemul solution from Reichhold Inc. Additionally, at any time after the application of the fibers as well as at any time during the processing of the article, the former may be subjected to a stream of air or some other fluid, typically a pressurized gas or a moving stream of gas from, e.g., a fan, which serves to blow off any excess or loose fibers from the former.

In one alternative embodiment, the fibers may be applied directly to the former prior to dipping the former into the elastomeric bath. This embodiment embeds the fibers deeper into the elastomeric substrate when the article is compared to an article made from the embodiment wherein the fibers are applied to the coagulating elastomeric. Of course it should be understood that repeatedly alternating dipping with fiber coating provides an article exhibiting characteristics of each of these embodiments.

In any event, once the article has been dipped into the polymer bath and the desired quantity of fibers have been applied, prior to stripping the article from the former, the coated former may be dipped into a leaching tank in which hot water is circulated to remove the water-soluble components, such as residual calcium nitrates and proteins contained in the natural rubber latex and excess process chemicals from the synthetic polymer latex. This leaching process may generally continue for about 12 minutes at a water temperature of about 120° F. The fiber reinforced article is then dried on the former to solidify and stabilize it further. It should be understood that various conditions, processes, and materials may be used to form such articles.

With respect to latex elastomers, the article, for example, the glove, is then sent to a curing station where the elastomer is vulcanized, typically in an oven. The curing station initially evaporates any remaining water in the coating on the former and then proceeds to a higher temperature vulcanization. The drying may occur at a temperature of from about 85° C. to about 95° C., and the vulcanizing may occur at a temperature of from about 110° C. to about 120° C. For example, the glove may be vulcanized in a single oven at a temperature of 115° C. for about 20 minutes. Alternatively, the oven may be divided into four different zones with a former being conveyed through zones of increasing temperature. For instance, the oven may have four zones with the first two zones being dedicated to drying and the second two zones being primarily for vulcanizing. Each of the zones may have a slightly higher temperature, for example, the first zone at about 80° C., the second zone at about 95° C., a third zone at about 105° C., and a final zone at about 115° C. The residence time of the former within each zone may be about ten minutes. The accelerator and vulcanizer contained in the latex coating on the former are used to crosslink the elastomer. The vulcanizer forms sulfur bridges between different elastomer segments and the accelerator is used to promote rapid sulfur bridge formation.

Upon being cured, the former may be transferred to a stripping station where the glove is removed from the former. The stripping station may involve automatic or manual removal of the glove from the former. For example, in one embodiment, the glove is manually removed and turned inside out as it is stripped from the former. By inverting the glove in this manner, the exterior of the glove on the former becomes the inside surface of the glove. It should be understood that any method of removing the glove from the former may be used, including a direct air removal process that does not result in inversion of the glove.

The solidified glove, or a plurality of solidified gloves, may then subjected to various post-formation processes, including application of one or more treatments to at least one surface of the glove. For instance, in certain embodiments, the glove may be halogenated to decrease tackiness of the interior surface. The halogenation (e.g., chlorination) may be performed in any suitable manner, including: (1) direct injection of chlorine gas into a water mixture, (2) mixing high density bleaching powder and aluminum chloride in water, (3) brine electrolysis to produce chlorinated water, and (4) acidified bleach.

Examples of such methods are described in U.S. Pat. No. 3,411,982 to Kavalir; U.S. Pat. No. 3,740,262 to Agostinelli; U.S. Pat. No. 3,992,221 to Homsy, et al.; U.S. Pat. No. 4,597,108 to Momose; and U.S. Pat. No. 4,851,266 to Momose, U.S. Pat. No. 5,792,531 to Littleton, et al., which are each herein incorporated by reference in their entirety. In one embodiment, for example, chlorine gas is injected into a water stream and then fed into a chlorinator (a closed vessel) containing the glove. The concentration of chlorine may be altered to control the degree of chlorination. The chlorine concentration may typically be at least about 100 parts per million (ppm). In some embodiments, the chlorine concentration may be from about 200 ppm to about 3500 ppm. In other embodiments, the chlorine concentration may be from about 400 ppm to about 1200 ppm. In yet other embodiments, the chlorine concentration may be about 800 ppm. The duration of the chlorination step may also be controlled to vary the degree of chlorination and may range, for example, from about 1 to about 20 minutes. In some embodiments, the duration of chlorination may be about 10 minutes.

Still within the chlorinator, the chlorinated glove or gloves may then be rinsed with tap water at about room temperature. This rinse cycle may be repeated as necessary. The gloves may then be tumbled to drain the excess water.

A lubricant composition may then be added to the glove, for example, it may be added into the chlorinator if halogenation is performed, followed by a tumbling process that lasts for about five minutes. However, it should be understood that a lubricant may be added with or without halogenation. In any event, the lubricant forms a layer on at least a portion of the interior surface to further enhance donning of the glove. In one embodiment, this lubricant may contain a silicone or silicone-based component. As used herein, the term “silicone” generally refers to a broad family of synthetic polymers that have a repeating silicon-oxygen backbone, including, but not limited to, polydimethylsiloxane and polysiloxanes having hydrogen-bonding functional groups selected from the group consisting of amino, carboxyl, hydroxyl, ether, polyether, aldehyde, ketone, amide, ester, and thiol groups. In some embodiments, polydimethylsiloxane and/or modified polysiloxanes may be used as the silicone component in accordance with the present invention. For instance, some suitable modified polysiloxanes that may be used in the present invention include, but are not limited to, phenyl-modified polysiloxanes, vinyl-modified polysiloxanes, methyl-modified polysiloxanes, fluoro-modified polysiloxanes, alkyl-modified polysiloxanes, alkoxy-modified polysiloxanes, amino-modified polysiloxanes, and combinations thereof. Examples of commercially available silicones that may be used with the present invention include DC 365 available from Dow Corning Corporation (Midland, Mich.), and SM 2140 available from GE Silicones (Waterford, N.Y.). However, it should be understood that any silicone that provides a lubricating effect may be used to enhance the donning characteristics of the glove. The lubricant solution is then drained from the chlorinator and may be reused if desired. It should be understood that the lubricant composition may be applied at a later stage in the forming process, and may be applied using any technique, such as dipping, spraying, immersion, printing, tumbling, or the like.

The coated glove may then be put into a tumbling apparatus or other dryer and dried for about 10 to about 60 minutes (e.g., 40 minutes) at from about 20° C. to about 80° C. (e.g., 40° C.). The glove may then be inverted to expose the exterior surface, which may then be dried for about 20 to about 100 minutes (e.g., 60 minutes) at from about 20° C. to about 80° C. (e.g., 40° C.).

After the various processes described above, the glove may be inverted (if needed) to expose the exterior surface of the elastomeric article, for example, the glove. Any treatment, or combination of treatments, may then be applied to the exterior surface of the glove. Individual gloves may be treated or a plurality of gloves may be treated simultaneously. Likewise, any treatment, or combination of treatments, may be applied to the interior surface of the glove. Any suitable treatment technique may be used, including for example, dipping, spraying, immersion, printing, tumbling, or the like.

With respect to synthetic fibers that may be applied to the article, as stated above, they may be formed from a variety of thermoplastic polymers where the term “thermoplastic polymer” refers to a long chain polymer that repeatedly softens when exposed to heat and substantially returns to its original state when cooled to ambient temperature. As used herein with respect to fibers and or filaments, the term “polymer” generally includes, but is not limited to, homopolymers, copolymers, such as for example, block, graft, random, and alternating copolymers, terpolymers, etc., and blends and modifications thereof. As used herein, the term “blend” means a mixture of two or more polymers. Furthermore, unless otherwise specifically limited, the term “polymer” shall include all possible geometrical configurations of the molecule. These configurations include, but are not limited to, isotatic, synditatic, and random symmetries.

Exemplary thermoplastics include, without limitation, poly(vinyl) chlorides, polyesters, polyamides, polyfluoro-carbons, polyolefins, polyurethanes, polystyrenes, poly(vinyl) alcohols, caprolactams, and copolymers of the foregoing, and elastomeric polymers such as elastic polyolefins, copolyether esters, polyamide polyether block copolymers, ethylene vinyl acetates (EVA), block copolymers having the general formula A-B-A′ or A-B like copoly(styrene/ethylene-butylene), styrene-poly(ethylene-propylene)-styrene, styrene-poly(ethylene-butylene)-styrene, (polystyrene/poly(ethylene-butylene)/polystyrene, poly(styrene/ethylene-butylene/styrene), A-B-A-B tetrablock copolymers and the like.

Many polyolefins are available for fiber production, for example polyethylenes such as Dow Chemical's PE XU 61800.41 linear low density polyethylene (“LLDPE”) and 25355 and 12350 high density polyethylene (“HDPE”) are such suitable polymers. Fiber-forming polypropylenes include Exxon Chemical Company's Escorene® PD 3445 polypropylene and Montell Chemical Co.'s PF-304 and PF-015. Many other conventional polyolefins are commercially available and include polybutylenes and others.

Examples of polyamides and their methods of synthesis may be found in “Polymer Resins” by Don E. Floyd (Library of Congress Catalog No. 66-20811, Reinhold Publishing, New York, 1966). Particularly commercially useful polyamides are nylon-6, nylon 6,6, nylon-11 and nylon-12. These polyamides are available from a number of sources such as Emser Industries of Sumter, S.C. (Grilon® & Grilamid® nylons), Atochem Inc. Polymers Division of Glen Rock, N.J. (Rilsan® nylons), Nyltech of Manchester, N.H. (grade 2169, Nylon 6), and Custom Resins of Henderson, Ky. (Nylene 401-D), among others.

As stated above, staple fibers may be added. In some embodiments, staple fibers may be used to increase the strength, bulk, softness and smoothness of the article. Staple fibers may include, for instance, various polyolefin fibers, polyester fibers, nylon fibers, polyvinyl acetate fibers, cotton fibers, rayon fibers, nonwoody plant fibers, and mixtures thereof. In general, staple fibers are typically longer than pulp fibers. For instance, staple fibers typically have fiber lengths of 5 mm and greater.

The fibers used in the present invention may also be curled or crimped. The fibers may be curled or crimped, for instance, by adding a chemical agent to the fibers or subjecting the fibers to a mechanical process. Curled or crimped fibers may create more entanglement and void volume between the fibers and further increase the amount of fibers oriented in the z-direction as well as increase strength properties.

As stated, the type of synthetic fibers used in the invention may include bicomponent fibers. Bicomponent fibers are fibers that can contain two materials such as but not limited to in a side by side arrangement, in a matrix-fibril arrangement, wherein a core polymer has a complex cross-sectional shape, or in a core and sheath arrangement. In a core and sheath arrangement, generally the sheath polymer has a lower melting temperature than the core polymer to facilitate thermal bonding of the fibers. For instance, the core polymer, in one embodiment, may be nylon or a polyester, while the sheath polymer may be a polyolefin such as polyethylene or polypropylene. Such commercially available bicomponent fibers include “CELBOND” fibers marketed by the Hoechst Celanese Company.

Besides or in addition to synthetic fibers, pulp fibers may also be added to the article. The pulp fibers used may be soft wood fibers having an average fiber length of greater than 1 mm, and particularly from about 2 to 5 mm based on a length weighted average. Such fibers may include northern softwood craft fibers, redwood fibers, and pine fibers. Secondary fibers obtained from recycled materials may also be used. In addition, hardwood pulp fibers, such as eucalyptus fibers, may also be utilized in the present invention.

Besides the above-mentioned fibers, thermomechanical pulp fibers may also be added to the base web. Thermomechanical pulp, as is known to one skilled in the art, refers to pulp that is not cooked during the pulping process to a lesser extent than conventional pulps. Thermomechanical pulp tends to contain stiff fibers and has higher levels of lignin. Thermomechanical pulp may be added to the base web of the present invention in order to create an open pore structure, thus increasing bulk and absorbency and improving resistance to wet collapse.

The pulp fibers may be added generally simultaneously with synthetic fibers in a process known as a coform process. In general, “coform” means a process in which at least one meltblown die is arranged near a chute through which other materials are added to the web while it forms. Such other materials may include, for example, pulp, superabsorbent particles, cellulose, or staple fibers. Coform processes are described in U.S. Pat. No. 4,818,464 to Lau and U.S. Pat. No. 4,100,324 to Anderson et al., which are incorporated by reference.

As described above, besides containing various nonelastic materials, the fibers used in the present invention may also contain an elastomeric component. By containing such an elastomeric component, the article should exhibit improved elasticity and strength since both the latex substrate and added fibers comprise elastomeric components.

In general, any material known in the art to possess elastomeric characteristics may be used in the present invention as an elastomeric component. Suitable elastomeric resins include, but are not limited to, block copolymers having the general formula A-B-A′ or A-B, where A and A′ are each a thermoplastic polymer endblock which contains a styrenic moiety such as a poly(vinyl arene) and where B is an elastomeric polymer midblock such as a conjugated diene or a lower alkene polymer. Block copolymers for the A and A′ blocks, and the present block copolymers are intended to embrace linear, branched and radial block copolymers. In this regard, the radial block copolymers may be designated (A-B)m-X, wherein X is a polyfunctional atom or molecule and in which each (A-B)m-radiates from X in a way that A is an endblock. In the radial block copolymer, X may be an organic or inorganic polyfunctional atom or molecule and m is an integer having the same value as the functional group originally present in X. It is usually at least 3, and is frequently 4 or 5, but not limited thereto. Thus, in the present invention, the expression “block copolymer,” and particularly “A-B-A” and “A-B” block copolymer, is intended to embrace all block copolymers having such rubbery blocks and thermoplastic blocks as discussed above, which may be extruded (e.g., by meltblowing), and without limitation as to the number of blocks.

The elastomeric component may be formed from, for example, elastomeric (polystyrene/poly(ethylene-butylene)/polystyrene) block copolymers. Commercial examples of such elastomeric copolymers are, for example, those known as KRATON® materials which are available from Shell Chemical Company of Houston, Tex. KRATON® block copolymers are available in several different formulations, a number of which are identified in U.S. Pat. Nos. 4,663,220, 4,323,534, 4,834,738, 5,093,422 and 5,304,599, which are incorporated herein by reference.

Polymers composed of an elastomeric A-B-A-B tetrablock copolymer may also be used in the practice of this invention. Such polymers are discussed in U.S. Pat. No. 5,332,613 to Taylor et al. In such polymers, A is a thermoplastic polymer block and B is an isoprene monomer unit hydrogenated to substantially a poly(ethylenepropylene) monomer unit. An example of such a tetrablock copolymer is a styrene-poly(ethylene-propylene)-styrenepoly(ethylene-propylene) or SEPSEP elastomeric block copolymer available from the Shell Chemical Company of Houston, Tex. under the trade designation KRATON® G-1657.

Other exemplary elastomeric materials which may be used include polyurethane elastomeric materials such as, for example, those available under the trademark ESTANE® from B.F. Goodrich & Co. or MORTHANE® from Morton Thiokol Corp., polyester elastomeric materials such as, for example, those available under the trade designation HYTREL® from E. I. DuPont De Nemours & Company, and those known as ARNITEL®, formerly available from Akzo Plastics of Arnhem, Holland and now available from DSM of Sittard, Holland.

Other suitable materials include polyester block amide copolymers such as those available under the trade designation PEBAX® from ELF Atochem Inc. of Glen Rock, N.J. Examples of the use of such polymers may be found in U.S. Pat. Nos. 4,724,184, 4,820,572 and 4,923,742 to Killian. Elastomeric polymers may also include copolymers of ethylene and at least one vinyl monomer such as, for example, vinyl acetates, unsaturated aliphatic monocarboxylic acids, and esters of such monocarboxylic acids. The elastomeric copolymers and formation of elastomeric nonwoven webs from those elastomeric copolymers are disclosed in, for example, U.S. Pat. No. 4,803,117. Thermoplastic copolyester elastomers including copolyetheresters may also be used. Commercial examples of such copolyester materials are, for example, those known as ARNITEL®, formerly available from Akzo Plastics of Arnhem, Holland and now available from DSM of Sittard, Holland, or those known as HYTREL® which are available from E.I. DuPont de Nemours of Wilmington, Del. Formation of an elastomeric nonwoven web from polyester elastomeric materials is disclosed in, for example, U.S. Pat. No. 4,741,949 to Morman et al. and U.S. Pat. No. 4,707,398 to Boggs.

Elastomeric olefin polymers are also available from Exxon Chemical Company of Baytown, Tex. under the trade name ACHIEVE® for polypropylene based polymers and EXACT® and EXCEED® for polyethylene based polymers. Dow Chemical Company of Midland, Mich. has polymers commercially available under the name ENGAGE®. Exxon generally refers to their metallocene catalyst technology as “single site” catalysts while Dow refers to theirs as “constrained geometry” catalysts under the name INSIGHT® to distinguish them from traditional Ziegler-Natta catalysts which have multiple reaction sites.

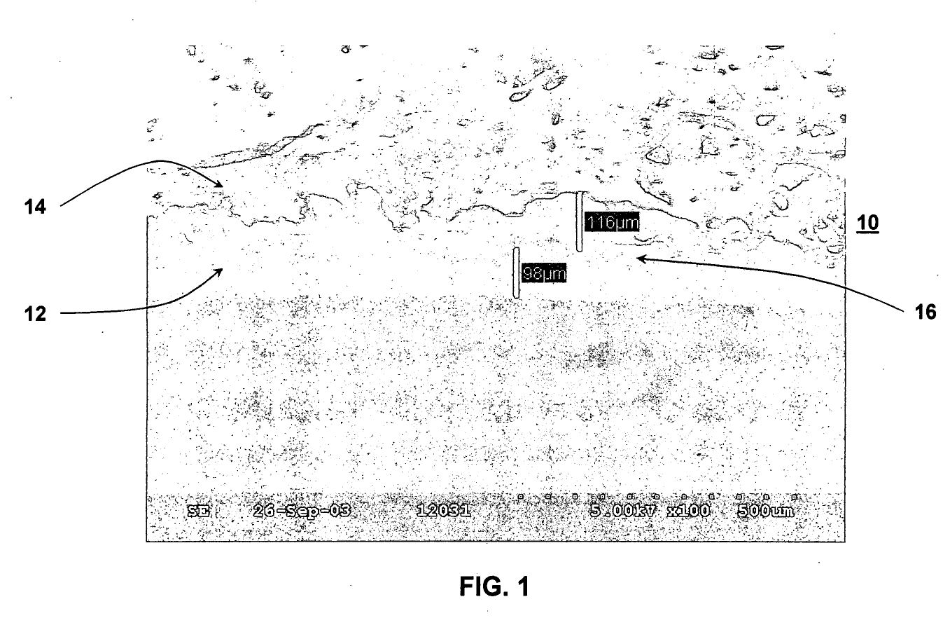

Turning now to FIG. 1, a scanning electron micrograph or SEM of one embodiment of the present invention is depicted. In this embodiment, a portion of an elastomeric article 10 is shown. The elastomeric article 10 contains a natural rubber latex substrate 12 and a plurality of elastomeric meltblown fibers 14 deposited thereon.

The meltblown fibers used in the invention may be continuous or discontinuous. Meltblown fibers have been conventionally made by extruding a thermoplastic polymeric material through a die to form fibers or filaments. As the molten polymer fibers exit the die, a high pressure fluid, such as heated air or steam, attenuates the molten polymer fibers to form fine filaments. Surrounding cool air is induced into the hot air stream to cool and solidify the filaments. The filaments are then randomly deposited onto the former to form a web or mat. When the fibers are deposited on the former, they are still tacky and stick to the surface of the former as well as to each other.

It can be seen in FIG. 1 that the fibers 14 are intermeshed with, and partially melted to one another. This results in a very strong fiber layer and in turn a strong article. If the fibers were short, they would not intermesh or otherwise interconnect as thoroughly. As such, the resulting fiber layer would not exhibit the strong, cohesive configuration found in the present invention. Short fibers, as seen in most flocking applications fall off easily from the substrate surface. Due to the use of hot meltblown fibers or nanofibers, the current invention provides fiber intermeshing without requiring the assistance of another component such as glue or some other adhesive.

It may also be seen that there exists a very well defined interface 16 between the substrate 12 and the fibers 14. As depicted in FIG. 1 the contact area between the fibers and the substrate at the interface 16 exceeds about 75%. This contact ensures that the fibers are firmly attached to the substrate and are not likely to shed or pile. Furthermore, as can be seen in FIG. 1, the fiber layer is clearly a dominant feature. In fact, it has been found that application of the fibers may completely seal the substrate surface. This discovery is desirable in that it may prove useful to provide a latex article wherein the latex itself is sealed within the fiber layer or is at least covered on one surface by the fiber layer. Such an article may be used where the properties of latex are desirable but the latex substrate must be prevented from coming into direct contact with the skin. An article of this nature may prove useful in minimizing and perhaps preventing skin allergy reaction with latex articles which otherwise might occur.

Additionally, though the halogenation process was described earlier in the specification, another unique advantage discovered in the present invention is that the application of fibers on an elastomeric article serves to decrease the tackiness of the article thus rendering the need for halogenation unnecessary. It has been found in practice, that the fibers at least partially cover the substrate surface. This essentially forms a barrier layer on the surface of the article. As such, the tackiness associated with the latex is replaced by a fiber coated surface. The fiber coated surface does not require any further surface treatment. Such a surface treatment otherwise would normally have been practiced and in some cases have been necessary to minimize tackiness. Moreover, should any treatment be necessary to add other benefits, the fiber layer would be found to be more accommodating to surface modification.

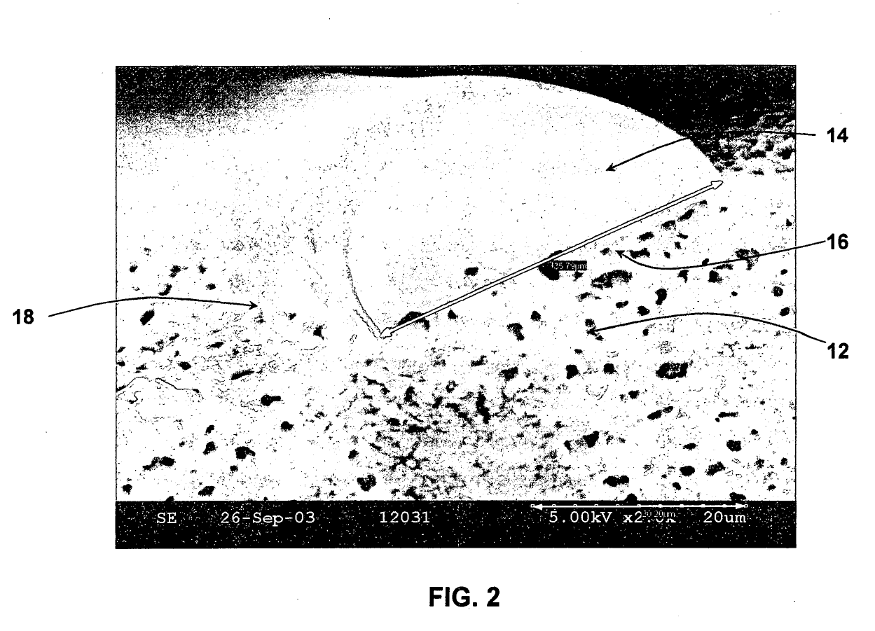

Turning now to FIG. 2, an exemplary meltblown fiber 14 is depicted on the substrate 12. It is readily seen in this FIG. that the fiber is deformed upon application to the substrate. For example, a typical meltblown fiber may start with a cross section of about 10-15 μm and it can be seen that because the meltblown fiber is still hot enough to deform upon contact with the substrate, it spreads outward. In this case, the surface contact or interface 16 is about 35.79 μm in length. This deformation results in a nearly continuous interface with the substrate and this ensures a maximum bonding between the fiber and the substrate. As a result, the fiber is strongly bonded to the substrate. In fact, it can be seen along one side 18 of the fiber that the fiber partially melts and resolidifies within the porous surface of the substrate itself. As stated earlier, compared to the traditional flocking process, no adhesive or glue is required.

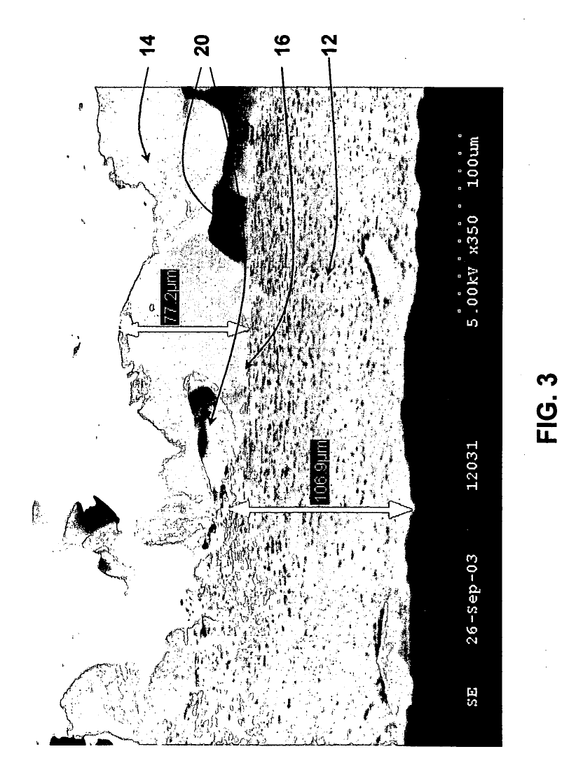

Looking again to FIG. 1, it can be seen that the fiber layer is thicker than the substrate layer. Specifically the former is about 116 μm whereas the latter is about 98 μm. However, turning now to FIG. 3, which depicts a similar article 10, it can be seen that the fiber layer may alternatively be made thinner than the substrate layer depending upon the properties desired. In FIG. 3, the fiber layer is about 77.2 μm whereas the substrate layer is about 106.9 μm.

The ability to control the fiber thickness on the latex substrate may be considered a useful aspect of the invention. In some embodiments, the fiber layer may desirably be made thinner than the latex layer while in other embodiments, the opposite may be desirable. For example, a thicker fiber layer may be desired if the article is a glove used for handling oil or heavy duty tasks whereas a thinner fiber layer may be desirable for an article that requires greater dexterity such as a surgical glove. The thickness of each layer is dependent upon factors such as the viscosity of the polymer bath that forms the substrate, the residence time that the former is in the bath, the quantity of fibers applied to the substrate, etc. These parameters are adjustable during the manufacturing process and are understood by those skilled in the art.

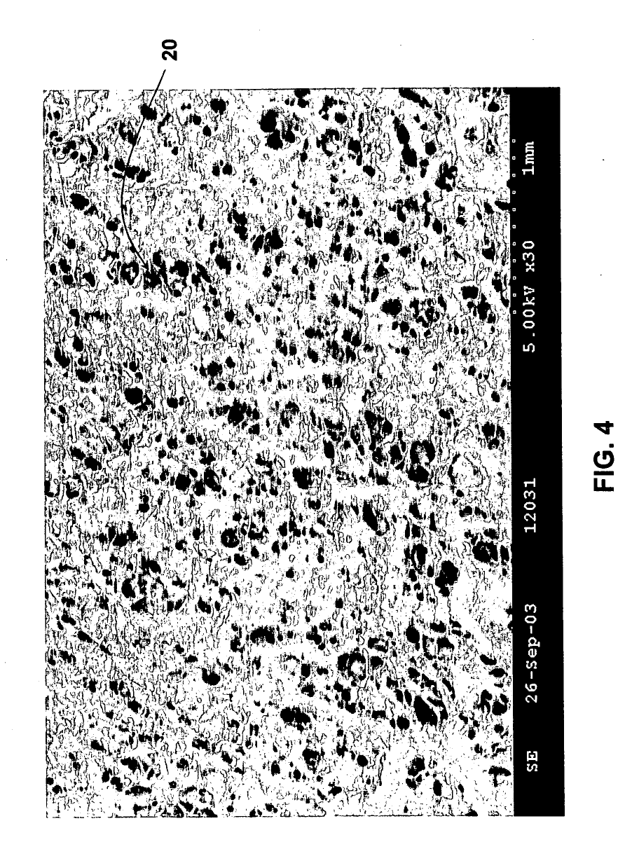

It can also be seen in FIG. 3, that pores 20 are formed in the article 10. These pores provide pockets capable of retaining lubricants as well as other additional desirable treatments and dispensing the same to the wearer. FIG. 4 depicts the surface structure of the article 10 and the pores 20 wherein the pores 20 are readily visible. The unique microporous structure of the fiber layer provide the article 10 multiple additional benefits such as enhanced breathability, enhanced moisture and water absorption, and reduced contact area with skin.

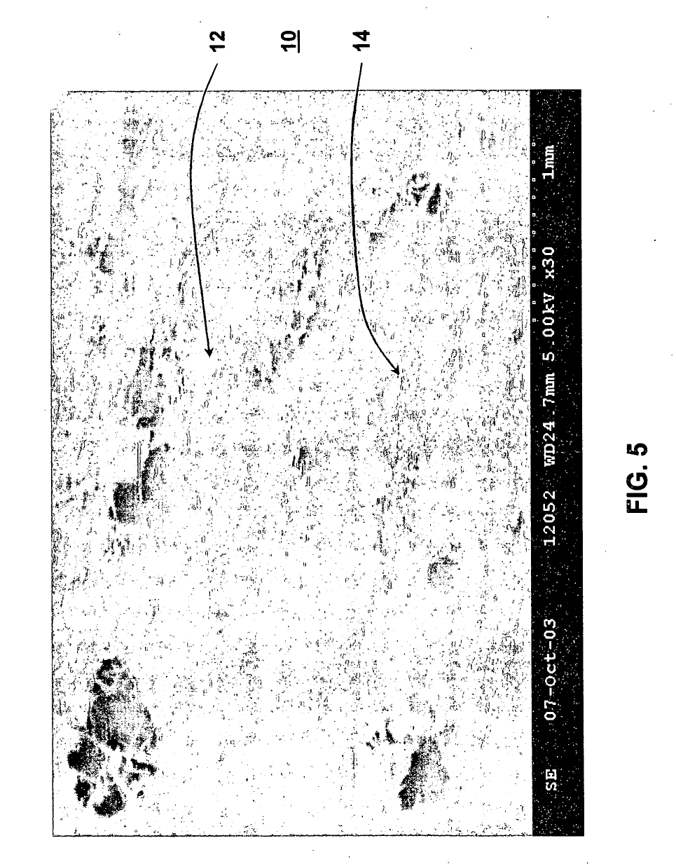

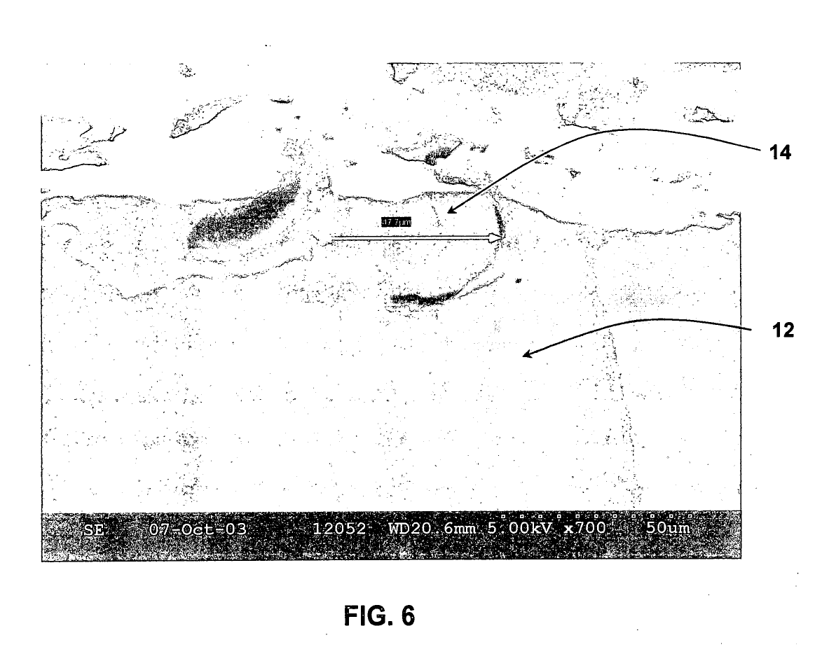

In another aspect of the invention, the fiber coating may be applied prior to dipping the former in the latex polymer. This would allow the latex polymer to envelop the fiber layer, thereby providing the opportunity to have the fiber partially or fully embedded into the latex layer., FIG. 5 depicts such an alternative embodiment of the present invention. In FIG. 5, the fibers 14 are first applied to the former and then the former is dipped into the elastomeric polymer thus subsequently forming the elastomeric substrate 12. This process produces a wholly different structure when viewed through the scanning electron microscope. As can be seen in FIGS. 5 and 6, a large number of the fibers are almost totally embedded within the latex substrate. Such a unique feature allows the production of fiber reinforced articles with fully integrated fiber and latex properties. In addition, this allows the production of fiber reinforced articles wherein both sides of the article are coated with one side fully embedded in the latex.

### ILLUSTRATIVE EXAMPLE

As an illustrative example of one embodiment of the present invention, a glove 10 may be manufactured. In the process, a porcelain former would be conveyed into a preheated oven at approximately 75 to 80° C. for about 20 minutes to evaporate any water that might be present. The former would then be dipped into a bath containing a coagulant having 10% calcium nitrate to enable the polymer latex to deposit and coagulate onto the former, 10% calcium carbonate powder to aid in releasing the completed glove from the former, and 0.5% of Tween-20, which is a surfactant to provide enhanced wetting so as to avoid the creation of a meniscus which might trap air between the form and deposited latex, particularly in the cuff area. The coagulant coated former would next be placed in the oven at 75° C. for approximately 2 minutes to allow the former to evaporate the water from the coagulant mixture leaving calcium nitrate, calcium carbonate powder, and the surfactant on the surface of the former.

Once the former is coated with the coagulant, it may then be coated with fibers or dipped into a polymer bath:

The coagulant coated former described above would next be dipped into a continuously stirred latex bath containing at least the following components: approximately 28% of compounded HA latex (46.8% of 60% HA Latex), 0.2% Ammonium Laureate, 0.5% Potassium Hydroxide, 0.75% SS Cure A, 1.5% Part B2-T, 0.15% Beveloid, and 50% water, for about 7 seconds. The latex coated former would then be transferred into a fiber coating station where meltblown fiber layer from Kraton is coated. The thickness and the size of the fibers are controlled by the die-tip and air flow of the fiber coating line. The former would next be subjected to a stream of air or some other fluid, typically a pressurized gas or a moving stream of gas from, e.g., a fan, which serves to blow off any excess or loose fibers from the former. After this, the fiber coated former would be coated with a 2% synthemul 907 solution for assisting adhesion and glove donning. The resulting glove would then be cured at 120° C. for 20 minutes. The cured article would then be allowed to cool on the former. Once cooled, the glove is stripped from the former.

Alternatively, the coagulant coated former from above could be transferred into a fiber coating station where the fiber layer is coated before the polymer dip. Once coated with the desirable quantity of fibers, the former could then be dipped into a latex bath of similar composition as that described above. The process would be similar with respect to curing and coating with synthemul 907 solution if desired.

Besides meltblown fibers, it should be understood that other processes may be used as well. One such process includes the application of spunbond fibers. Spunbond fibers are typically produced by heating a thermoplastic polymeric resin to at least its softening temperature, then extruding it through a spinnerette to form continuous fibers or filaments, which can be subsequently fed through a fiber draw unit. From the fiber draw unit the filaments are spread onto the former in a manner similar to that used in the meltblown application. However, since spunbond filaments are not tacky they must be applied to a wet or tacky surface. In one application, the spunbond filaments are applied directly to the still wet elastomeric surface coating the former after the former is removed from the polymer bath.

In addition to the above polymeric fibers, pulp fibers and/or staple fibers may be added as disclosed above. As an example, one method of adding pulp fibers to the polymeric fibers is to extrude the thermoplastic polymeric resin through a die or spinnerette to form continuous fibers such as described in the meltblown application above. The fibers are attenuated into filaments by the use of a primary fluid stream of heated air or steam. This primary fluid stream is merged with a secondary fluid stream containing individualized wood pulp fibers. As the two streams merge, the polymeric fibers are integrated with the pulp fibers in a single step.

It is contemplated that the fiber reinforced elastomeric articles of the present invention will be tailored and adjusted by those of ordinary skill in the art to accommodate various desirable features. Accordingly, while this invention has been described by reference to certain specific embodiments and examples, it will be understood that this invention is capable of further modifications. This application is, therefore, intended to cover any variations, uses or adaptations of the invention following the general principles thereof, and including such departures from the present disclosure as come within known or customary practice in the art to which this invention pertains and fall within the limits of the appended claims.

1. An elastomeric article comprising an elastomeric latex substrate impregnated with a plurality of elastomeric fibers having a length substantially greater than the width of the fibers.

2. The article of claim 1 wherein the fibers are entangled with one another and partially melted into the body of and onto the surface of the elastomeric latex substrate.

3. The article of claim 1 wherein the fibers form a layer partially overlying the elastomeric latex substrate.

4. The article of claim 3 wherein the fiber layer is thicker than the elastomeric latex substrate.

5. The article of claim 4 wherein the fiber layer is from about one times to about two times as thick as the elastomeric latex substrate.

6. The article of claim 3 wherein the fiber layer is thinner than the elastomeric latex substrate.

7. The article of claim 6 wherein the fiber layer is from about one quarter to about one times as thick as the elastomeric latex substrate.

8. The article of claim 1 wherein the fibers are generally smaller than about 10 microns in average diameter prior to deposition onto the elastomeric latex substrate and once deposited onto the elastomeric latex substrate, the fibers flatten and spread to about 20 microns across an interface formed between the elastomeric latex substrate and the fiber.

9. The article of claim 1 comprising any of a glove, a condom, a boot, an incontinent pad, a blanket, and apparel.

10. The article of claim 1 wherein the elastomeric latex substrate comprises a latex polymer.

11. The article of claim 1 wherein the elastomeric latex substrate comprises a synthetic rubber.

12. The article of claim 1 wherein the elastomeric latex substrate comprises a nitrile polymer.

13. The article of claim 1 wherein the elastomeric latex substrate comprises a neoprene polymer.

14. An elastomeric article comprising an elastomeric latex substrate combined with a plurality of tacky polymeric fibers, the fibers forming a coherent mat and at least partially adhering to one another.

15. The article of claim 14 having at least one surface completely coated by the fibers.

16. The article of claim 14 having wherein the elastomeric latex substrate is enveloped within the coherent mat of fibers.

17. The article of claim 14 wherein the fibers are at least partially impregnated within the elastomeric latex substrate.

18. The article of claim 14 wherein the fibers comprise meltblown fibers.

19. The article of claim 14 wherein the fibers comprise nanofibers.

20. The article of claim 14 wherein the fibers are continuous.

21. The article of claim 14 wherein the fibers are elastomeric.

22. The article of claim 14 comprising an interface between the elastomeric latex substrate and the plurality of tacky polymeric fibers.

23. The article of claim 14 comprising a porous structure capable of containing and releasing a treatment.
